(19) United States
(12) Patent Application Publication
(10) Pub. No.: US 2013/0014162 A1
(43) Pub. Date: Jan. 10, 2013

(54) CHANNEL SWITCHING METHOD

(75) Inventors: Yu-Jen Chen, New Taipei City (TW); Wen-Kang Wei, New Taipei City (TW)

(73) Assignee: AMTRAN TECHNOLOGY CO. LTD, New Taipei City (TW)

(21) Appl. No.: 13/244,616

(22) Filed: Sep. 25, 2011

(30) Foreign Application Priority Data
Jul. 4, 2011 (TW) 100123523

(51) Int. Cl. H04N 21/00

(52) U.S. Cl. 725/38

(57) ABSTRACT

A channel switching method is proposed. The channel switching method is adapted to a video playing system, and includes following steps. Video of a first channel is received and played, and a command to select a second channel is received. Information indicating a status of the second channel is queried, acquired and determined. It further switches to the second channel and plays the video of the second channel if the second channel is not in a commercial playing status.

### CROSS-REFERENCE TO RELATED APPLICATION

This application claims the priority benefit of Taiwan application serial no. 100123523, filed on Jul. 4, 2011. The entirety of the above-mentioned patent application is hereby incorporated by reference herein and made a part of this specification.

### BACKGROUND

1. Field of the Invention

The invention relates to a channel switching method, and, particularly, the invention relates to channel switching method adapted to a video playing device having only a single tuner to query playing statuses of other channels in addition to a currently playing channel.

2. Description of Related Art

During the broadcast of a television (TV) channel, commercials are inserted in the middle of TV programs played in the channel. However, not all of the commercial contents are wanted by the audience, so most of the audience usually switch the channels to skip the commercials during watching TV. In the process of searching another desired program by switching channels, the TV is usually switched to another channel which is also playing unwanted commercials, so the audience has to continually switch the channels until a channel not playing commercials is found. Accordingly, the audience may have unpleasant experience due to the disturbance of the commercials during watching TV, and have to spend a lot of time on checking the channel status and searching for the desired TV program. If the audience still wants to watch the program of the original channel after switching to another channel previously, the audience has to manually switch back to the original channel and check whether the commercial time of the original channel already ends.

The related arts provide some methods for recognizing the content of a channel to assist analyzing and comparing sounds or images of the channel content, so the current status of the channel identifying whether a program or a commercial is playing in the channel can be determined. However, the related arts are generally applied to a personal video recording (PVR) device or a device having a recording function (for example, a set-top-box (STB) with media storage) to provide a function of skipping the commercials during a video recording process, or reducing commercial images and/or volumes of sound thereof to reduce disturbance to the audience. The statuses of other channels cannot be determined by the methods disclosed in the related arts unless the TV has additional tuner to receive the contents of at least two channels at the same time. Therefore, it is lack of a method to reduce the unpleasant audience experience due to the disturbance of the commercial when watching TV having only one tuner, and also lack of a method for effectively querying current statuses of the other channels during watching TV program.

### SUMMARY

The invention is directed to a channel switching method adapted to a video playing system having only a single tuner to query playing statuses of other channels in addition to a currently playing channel.

According to an embodiment, the invention provides a channel switching method, which is adapted to a video playing system, and includes following steps: receiving and playing video of a first channel; receiving a command to select a second channel; querying information indicating a status of the second channel; acquiring information indicating the status of the second channel and determining the status of the second channel; and switching to the second channel and playing video of the second channel if the second channel is not in a commercial playing status.

According to an embodiment, the invention provides a channel switching method, which is adapted to a video playing system, and includes following steps: receiving and playing video of a first channel; receiving a command to switch to a previous or next channel of the first channel; querying and acquiring information indicating a status of a second channel which is arranged previous or next to the first channel; determining the status of the second channel; if the second channel is not in a commercial playing status, switching to the second channel and playing video of the second channel; and if the second channel is in a commercial playing status, querying information indicating a status of a third channel which is arranged previous or next to the second channel.

According to an embodiment, the invention provides a channel switching method, which is adapted to a video playing system, and includes following steps: receiving a command to track a first channel; receiving and playing video of a second channel; querying and acquiring information indicating a status of the first channel; determining the status of the first channel; and if the first channel is in a program playing status, switching to the first channel and playing the video of the first channel.

Based upon the aforementioned descriptions, according to the aforementioned embodiments of the invention, channel switching methods are provided. By using the proposed methods, the channels can be effectively switched to reduce an unpleasant experience of the audience due to the commercial disturbance, so as to improve a channel switching experience of the audience.

Several embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a video system which maintains the content status information of channels according to an embodiment of the present invention.

FIG. 2 illustrates a video system according to another embodiment of the present invention.

FIG. 3A illustrates a video system according to another embodiment of the present invention.

FIG. 3B illustrates another video system according to another embodiment of the present invention.

FIG. 4 is a functional block diagram illustrating a video playing system according to an embodiment of the present invention.

FIG. 5 is a flowchart illustrating a switching channel method according to an embodiment of the present invention.

FIG. 6 is a flowchart illustrating a switching channel method according to another embodiment of the present invention.

FIG. 7 is a flowchart illustrating a switching channel method according to another embodiment of the present invention.

FIG. 8 is a flowchart illustrating a switching channel method according to another embodiment of the present invention.

### DETAILED DESCRIPTION OF DISCLOSED EMBODIMENTS

The invention provides several embodiments to respectively introduce a corresponding video system which is capable of querying the content information of each channel. The systems provided by the invention are different to the conventional server-client system architecture in the related arts. The proposed systems can be applied to a video system, such as a video playing device, which has only a single video content receiver. The proposed system can provide the function of effectively switching channels or satisfying related requirements when watching the video content played by the video system. The video playing system can be, for example, a television device, a set-top-box (STB) or a computer. Moreover, the video content receiver can be a tuner or a stream input. In addition, the present invention provides several embodiments to respectively introduce a corresponding method for switching channels playing different video contents.

The present invention provides some behaviours for efficiently switching channels. When the audience would like to switch to a channel by using a number pad of a remote controller or other input devices, the video system queries information of a current status of the channel. When the current status of the queried channel is a “program playing” status, the video system will be switched to the queried channel directly. When the current status of the queried channel is a “commercial playing” status, the video system will notify the audience by displaying a message showing that the queried channel is now playing a commercial, and the audience can determine whether to switch to the queried channel. When the audience still wants to switch to the queried channel after the current status of the queried channel is shown, the audience can press a key of the input device to agree the switch; otherwise, the video system will remove the notifying message and keep playing the current channel after a predetermined period of time. According to such method, the situation that the audience keeps switching channels and finds the switched channels are all playing commercial can be avoided. Thus the pleasant channel switching experience when watching TV is provided to the audience. Moreover, the video system can be applied to other scenarios according to the method of the present invention. For example, when the audience sequentially switches to the next channel (CH down) or previous channel (CH up), a subsequent channel playing a commercial will be skipped according to the query result, and the video system will switch to the channel next to or previous to the subsequent channel if the channel is playing program.

When implementing the aforementioned behaviour of channel switching, a commercial analysis (CA) unit could be utilized. In practical system architecture, the CA unit can be a single-stream CA unit or a multi-stream CA unit, where the single-stream CA unit could be software or device capable of recognizing the content in a commercial of one video stream, and the multi-stream CA unit is capable of recognizing the content in commercials of more than two streams at the same time.

There are two methods of utilizing the CA unit to implement the aforementioned behaviour of channel switching. In the first method, the single-stream CA unit is embedded in the video equipment. After the CA unit analyzes the content of the queried channel which the video equipment is proposed to be switched to, the video equipment can perform the scenario for the behaviour of channel switching. Since the video equipment is required to simultaneously provide content playing of the current channel and content analysis of the queried channel, the video equipment must have at least two tuners to receive contents of two different channels. In the second method, the server-client architecture is provided to perform content analysis of all channels, wherein a server is utilized to analyze the contents of all channels and maintain a channel status table, and a client device can acquire the status of a specific channel by accessing the channel status table. However, the server is required to have the multi-stream CA unit and a plurality of tuners, so that the cost of the server hardware would be high. Therefore, the invention also provides several embodiments to respectively introduce different system architectures which are capable of providing same function without two or more tuners or the multi-stream CA unit. The proposed embodiments of the present invention are implemented through a concept of sharing channel status or channel stream via network.

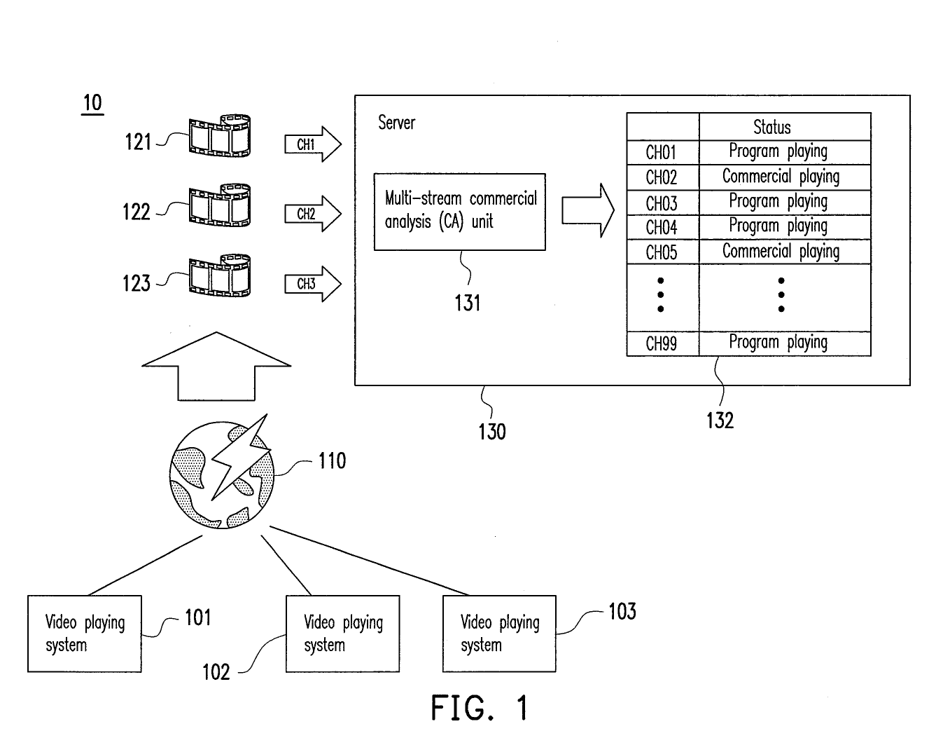

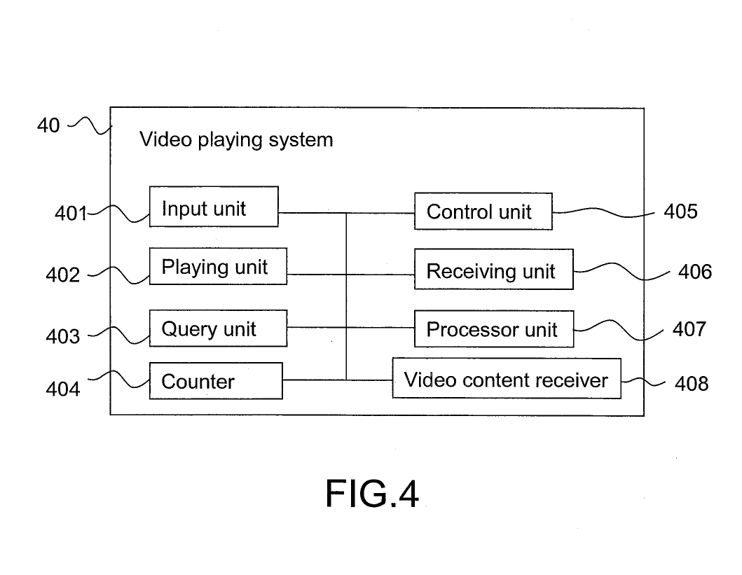

FIG. 1 illustrates a video system which maintains the content status information of channels according to an embodiment of the present invention. Referring to FIG. 1 and FIG. 4, the video system 10 includes a plurality of video playing devices 101, 102, 103, the Internet 110 and a server 130. The video playing devices 101, 102 and 103 respectively have components and corresponding functions similar to that of a video playing system 40. The video playing devices 101, 102 and 103 are respectively connected to the server 130 through the Internet 110. The video playing devices 101, 102 and 103 respectively include a query unit 403, a control unit 405, a receiving unit 406 and a video content receiver 408.

The video content receiver 408 receives a video content of a channel for playing and can be switched to another channel. The video content of the playing channel can be one of video contents 121, 122 and 123 of a plurality of channels CH1, CH2 and CH3. The query unit 403 is configured for connecting at least an external device, and sending a query request to the external device, where the query request is to query current status information of a specific channel. The receiving unit 406 receives the status information of the specific channel from the external device. The control unit 405 determines, according to the status information of the specific channel, whether to switch the receiving channel of the video content receiver 408 in order to receive the video content of the specific channel. The control unit 405 can also be a part of a processor unit 407 or other components. In the present embodiment, the external device is, for example, the server 130.

The video playing devices 101, 102 and 103 can be television devices, STBs or computers. Moreover, the video content receiver 408 can be a tuner or a stream input. The server 130 is connected to the video playing devices 101, 102 and 103 through the Internet 110, and is configured for obtaining the video contents 121, 122 and 123 of the channels from the video playing devices.

The server 130 includes a multi-stream CA unit 131 and maintains a channel status table 132. The query unit 403 and the receiving unit 406 of the video playing devices are connected to the server 130. The multi-stream CA unit 131 receives the video contents 121, 122 and 123 of the channels from the video playing devices, and analyzes the video contents of the channels to obtain status information of the channels. The server 130 maintains the channel status table 132 according to the status information of each channel. In the channel status table 132, the server 130 maps each of the channels to the corresponding status information, for example, the channels CH1-CH99 are mapped to their current status information respectively. The status information could be at least a “program playing” status and a “commercial playing” status.

When the one of the video playing devices 101, 102 and 103 queries the server 130 for the status information of a specific channel, the server 130 replies the status information of the specific channel to the receiving unit 406 of the video playing device according to the channel status table 132. For example, when the video playing device 101 queries the server 130 for the status information of a specific channel (for example, the third channel CH3), the server 130 provides the status information of the specific channel to the video playing system 101. The invention is not limited thereto, and the video system 10 may include more than two servers, or more than three video playing devices.

In the video system 10, the server 130 is not required to have a multi-video content receiver, a multi-tuner or a multi-stream input. The video content of each channel is provided to the server 130 by the clients (for example, the video playing devices 101, 102 and 103) through the Internet 110, so that the server 130 is only required to have the multi-stream CA unit 131 utilized to dynamically analyze the content of each channel provided by the clients, so as to update the channel status table 132. In this way, each of the clients can query the server 130 for the playing status of a specific channel.

In the video system 10, it is unnecessary for the client to analyze the content of the specific channel, so the cost to implement the CA unit in each of the client devices is saved. Moreover, it is unnecessary for the client to spend its computing power to undertake the burden of commercial analysis. The client devices only have to share the content of the currently watched channel with the server 130, so only a single-video content receiver, a single-tuner or a single-stream input is required to be configured in the client devices. It is unnecessary for the server 130 to have a multi-tuner or a tuner array to receive contents from multiple channels simultaneously. The contents of the channels can be obtained from a plurality of remote client devices by utilizing time division multiplexing or other network sharing techniques, and each client device is required to contribute the content of a channel in a very short period of time, or just part of the channel content to the server 130.

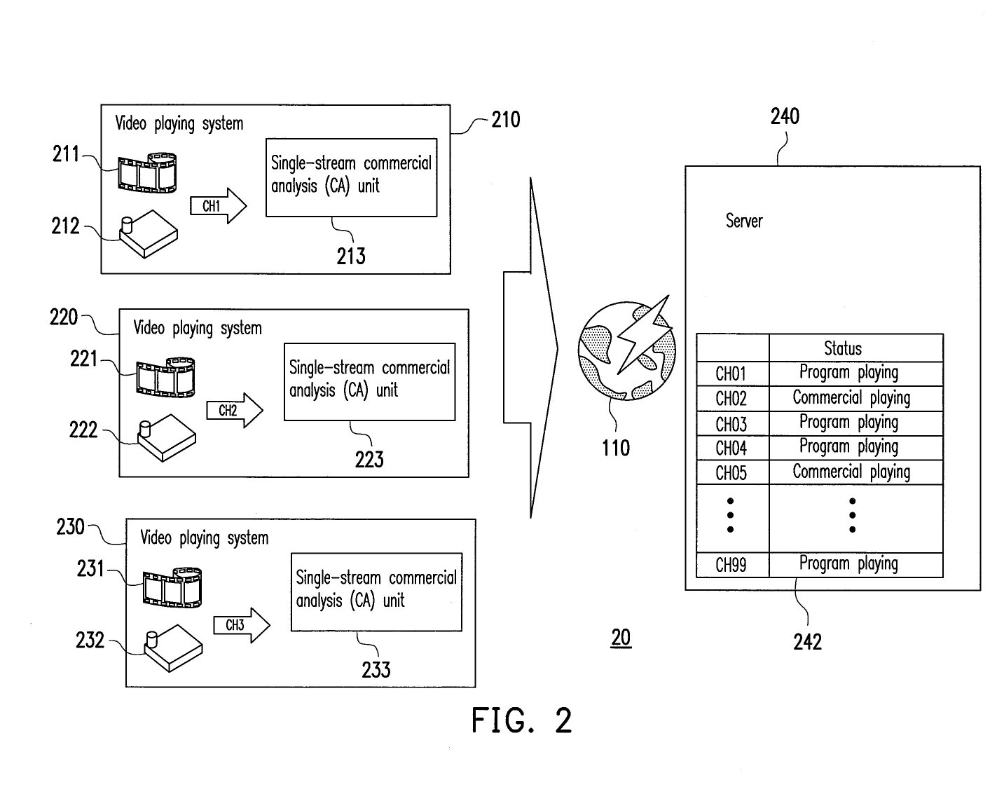

FIG. 2 illustrates a video system according to another embodiment of the present invention. Referring to FIG. 2, the video system 20 includes a plurality of video playing devices 210, 220 and 230, the Internet 110 and a server 240. The video playing devices 210, 220 and 230 respectively have components and corresponding functions similar to that of the video playing system 40. The video playing devices 210, 220 and 230 are respectively connected to the server 240 through the Internet 110.

Referring to FIG. 2, the video playing devices 210, 220 and 230 respectively include one video content receiver 212, 222 and 232. The video content receivers 212, 222 and 232 are respectively configured for obtaining the video content of each channel for playing, and the channel can be switched to another channel. For example, the video contents can be video contents 211, 221 and 231 of a plurality of channels CH1, CH2 and CH3. The video playing devices 210, 220 and 230 can be, for example, television devices, STBs or computers. Moreover, the video content receivers 212, 222 and 232 can be tuners or stream inputs.

In an embodiment of the present invention, the external device connected to the video playing devices is the server 240. The server 240 is connected to the video playing devices 210, 220 and 230 through the Internet 110 and configured for obtaining the video contents, for example, the video contents 211, 221 and 231 of the channels CH1, CH2 and CH3. The video playing devices 210, 220 and 230 respectively include one single-stream CA unit 213, 223 and 233. The single-stream CA units 213, 223 and 233 of the video playing devices 210, 220 and 230 are respectively configured to analyze the video content to obtain status information of a channel. For example, the single-stream CA units 213, 223 and 233 are respectively configured for obtaining the status information from analyzing the video contents 211, 221 and 231 of the channels CH1, CH2 and CH3.

Moreover, the server 240 maintains a channel status table 242 and connects to the video playing devices 210, 220 and 230 through the Internet 110 for obtaining the status information of one or more channels. The server 240 maintains the channel status table 242 according to the playing status information of each channel from the video playing devices. In the channel status table 242, the server 240 maps each of the channels to the corresponding status information. For example, the server 240 obtains a first type of status information corresponding to a first channel (in this example, the channel CH1), from a first number of the video playing devices, and meanwhile the server 240 also obtains a second type of status information from a second number of the video playing devices. The server 240 will then gather the received numbers of the status information and determine which type of the status information is the most one. If the number of the first type playing status information is the most one (such as, the first number is more than the second number in this example), the server will make the determination by majority and map the channel to the first type of status information in the channel status table 242.

When one of the video playing devices 210, 220 and 230 queries the server 240 for the status information of a specific channel, the server 240 provides the status information of the specific channel to the querying video playing device. The status information includes at least a “program playing” status and a “commercial playing” status. For example, when the video playing device 210 queries the server 240 for the status information of a specific channel (in this example, the third channel CH3), the server 240 provides the status information of the specific channel to the video playing system 210. However, the invention is not limited thereto, and the video system 20 may include more than two servers or include more than three video playing systems.

In the video system 20, the clients (for example, the video playing devices 210, 220 and 230) respectively have a single video content receiver and a single-stream CA unit. The clients simultaneously analyze the content of the currently watched channels and transmit the analysis results to the server 240 through the Internet 110. The server 240 maintains the channel status table 240 only according to the results gathered from the clients. When the client would like to query status information of a specific channel, the client can send a query to the server 240, and the server 240 will reply the status information of the specific channel according to the current channel status table 242.

In the video system 20, the data transmitted through the network only includes the computation or analysis result, queries of the status of a specific channel and the replying status information to the queries. Therefore, the overall system requires only very small bandwidth of network for data transmission. Moreover, the video system 20 can provide a more accurate method for analyzing the channels. Some of the prior arts disclose a method for monitoring the channels by man, but human error may be occurred in such method. Some other prior arts disclose a method for utilizing commercial analysis software or a hardware equipment for analyzing the channels, however the accuracy is limited by the algorithm and some commercial contents may be misjudged. Also, a channel broadcasted in different regions may have different statuses and the played commercials of the channel could be different in different regions, the server 240 of the present invention can divide client into groups based on the regions and maintain channel status tables of different regions respectively. According to the analysis results of a channel gathered from the clients in the same region, the status of the channel in this region can be determined by majority. Thus, the risks resulted from the misjudgement of the commercial analysis software or the hardware equipment can be reduced.

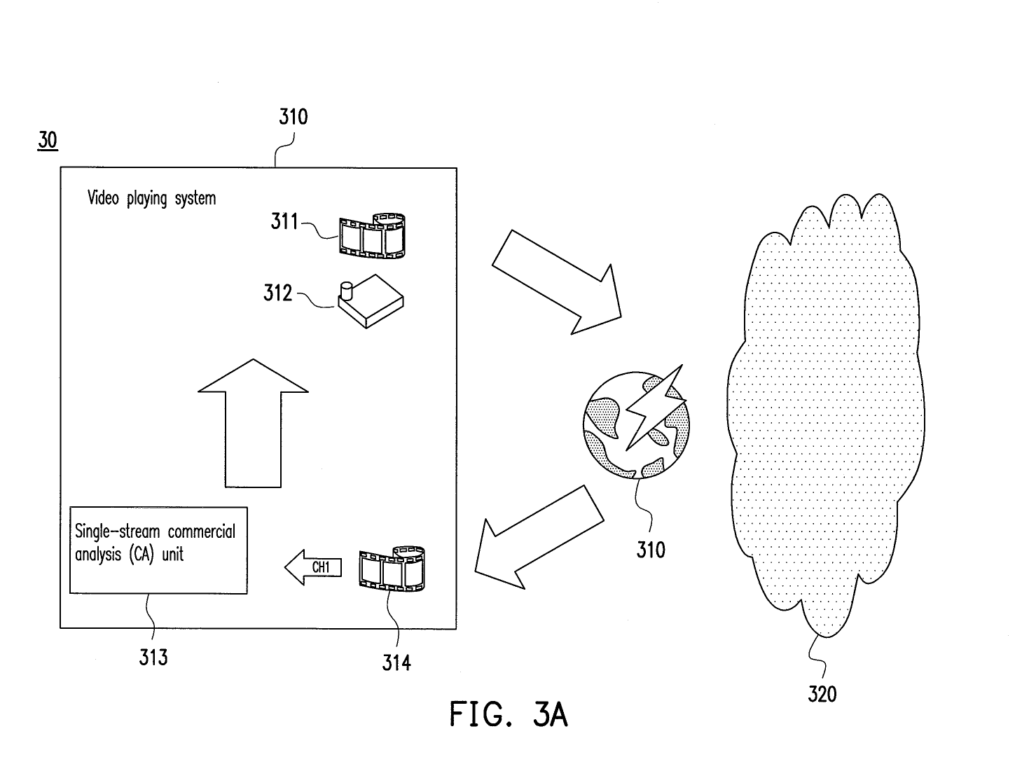

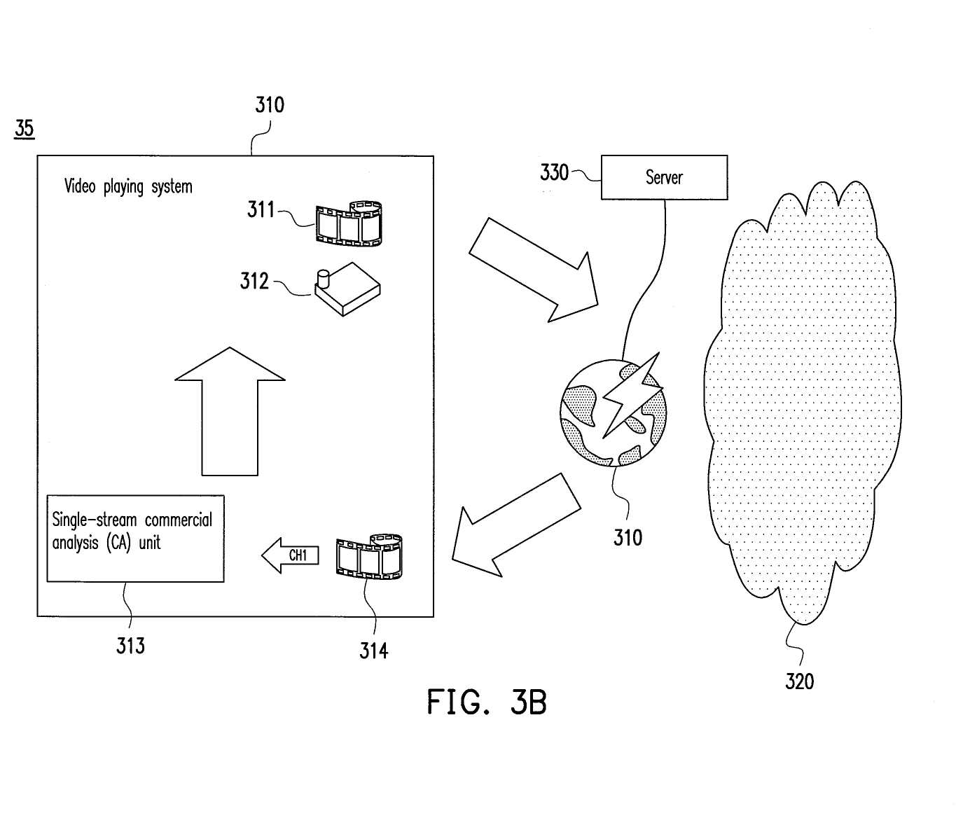

FIG. 3A illustrates a video system according to another embodiment of the present invention. Referring to FIG. 3A, the video system 30 includes a video playing device 310 connected to one or a plurality of other video playing devices (other clients 320) through Internet 110. In the present embodiment, the other clients 320 can be devices similar to the video playing device 310. The video playing device 310 and the other clients 320 respectively have components and corresponding functions similar to that of the video playing system 40.

Referring to FIG. 3A, the video playing device 310 only includes a video content receiver 312 and a single-stream CA unit 313. The video content receiver 312 is configured for obtaining a video content (for example, a video content 311) of a channel, and the single-stream CA unit 313 is configured for analyzing the video content of the channel to obtain status information of the channel. In the video system 30, the video playing device 310 is connected to the other clients 320 through the Internet 110 to exchange the status information of the other channels. Therefore, the video playing device 310 can transmit the obtained video content 311 to one of the other clients 320. On the other hand, the query unit 403 of the video playing device 310 can send a query request to an external device. In an embodiment of the present invention, the external device can be one of the other clients 320. When the external device receives the query request, it replies a playing frame of the specific channel to the video playing device 310 sending the query request. The single-stream CA unit 313 of the video playing device 310 will then analyze the playing frame of the specific channel. In another embodiment of the present invention, the video playing device 310 provides the status information of the currently watching channel to the other video playing systems, and meanwhile the query unit 403 of the video playing device 310 can query the other video playing systems for the playing status information. Thus, the video playing device 310 can collect the playing status information of the non-watching channels or maintain a playing status table of multiple channels from other video playing systems.

The video playing device 310 and the other clients 320 could be, for example, television devices, STBs or computers. Moreover, the video content receiver 312 of the video playing device 310 can be a tuner or a stream input. In addition, when a first video playing device (for example, the video playing device 310) has obtained the status information of a first channel (for example, the channel CH3) and needs the status of a second channel (for example, the channel CH1), the first video playing device can query a second video playing device, which obtained the status information of the second channel, through the Internet 110 for the channel content of the second channel.

In the video system 30, each of the clients (for example, the video playing device 310) has a single video content receiver and a single-stream CA unit. When a client wants to acquire a status information of a specific channel, it computes and analyzes the content of the specific channel in the background without querying a server through the Internet, and the content of the specific channel is provided by another video playing device on the Internet 110 which are opportunely playing the content of the specific channel.

FIG. 3B illustrates another video system according to another embodiment of the present invention. Referring to FIG. 3B, the video system 30 is similar to the video system 30 of FIG. 3A except including a server 330. The server 330 is connected to the video playing device 310 and other clients 320 through the Internet 110. The server 330 maintains the connections between each video playing systems, so a video playing system can query another video playing system to acquire the status information. For example, when a first video playing device (for example, the video playing device 310) wants to query status information of a second channel (a channel other than the currently watched channel of the video playing device 310), the server 330 assists the first video playing device to find a second video playing device having the status information of the second channel. Then, the first video playing device can query the second video playing device in the video content system 30 through the Internet 110 to acquire the status information or the content of the second channel. The first video playing device can also compute and analyze the channel content of the second channel in background when playing the content of the first channel.

FIG. 4 is a functional block diagram of a video playing system according to an embodiment of the present invention. Referring to FIG. 4, the video playing system 40 includes an input unit 401, a playing unit 402, a query unit 403, a counter 404, the control unit 405, a receiving unit 406, a processor unit 407 and a video content receiver 408. The input unit 401, the playing unit 402, the query unit 403, the counter 404, the control unit 405, the receiving unit 406, the processor unit 407 and the video content receiver 408 are connected to each other, and the processor unit 407 controls and coordinates the aforementioned units, modules or devices.

The input unit 401 receives an input command from the audience and is connected to the playing unit 402. The playing unit 402 is configured for playing a channel content of a channel. The video content receiver 408 is configured for obtaining a video content of a channel for playing, where the channel can be switched to another channel. The query unit 403 is configured for connecting with at least one external device and sending a query request to the external device. The query request queries the external device for status information of a specific channel. The receiving unit 406 also receives the status information of the specific channel from the external device. The control unit 405 determines, according to the status information of the specific channel, whether to switch the receiving channel of the video content receiver 408 in order to receive the video content of the specific channel. The query unit 403 and the receiving unit 406 are connected to the external device, for example, a server or another video playing device. The query unit 403 sends the query request to the external device, and then the receiving unit 406 receives the status information of the specific channel from the external device in response to the query request. The counter 404, connected to the input unit 401, counts a value n, including at least initializing the value n and increasing the value n to n+1. In addition, the control unit 405 connects to the query unit 403 and determines status information of a channel. In other embodiments of the present invention, the video playing system 40 can further include a single-stream CA unit (not shown) for analyzing the playing status of the obtained video content. The aforementioned descriptions are only for describing the embodiment of the present invention, the inventive scope of the concept of the invention is not limited thereto, and the aforementioned devices can also be integrated or replaced by other devices to implement the video playing system of the present invention. For example, the control unit 405 can be a part of the processor unit 407 or other devices, and the query unit 403 and the receiving unit 406 can be integrated as one component, and so forth.

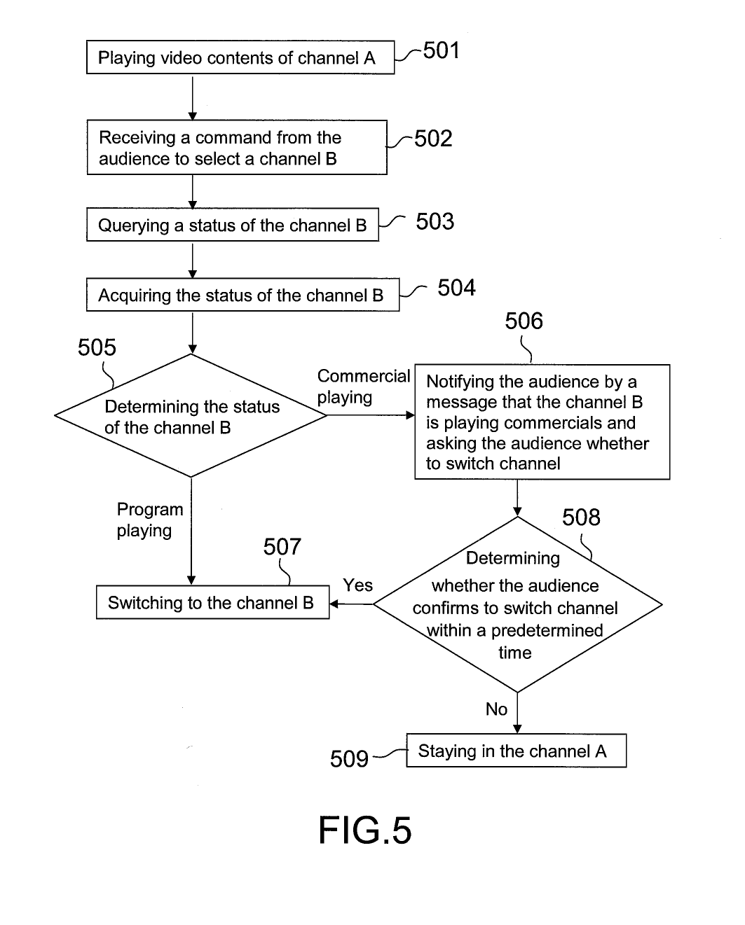

Moreover, the video playing system 40 can query the server for the status information of the channels, or acquire the status information of the channels not played in the video playing system 40 from other clients through the system architecture of FIG. 1 or FIG. 2. The system architecture of FIG. 1, FIG. 2, FIG. 3A and FIG. 3B can all assist the video playing system to acquire a current status of a specific channel, By utilizing the status information, the audience is benefited from the scenarios of channel switching when watching TV programs. The following methods of FIG. 5 to FIG. 8 are not limited to the system architecture of FIG. 1, FIG. 2, FIG. 3A and FIG. 3B, and other video systems or methods can also be utilized with the following methods to query the playing status of the channels.

FIG. 5 is a flowchart illustrating a switching channel method according to an embodiment of the present invention. Referring to FIG. 4 and FIG. 5, in the embodiment, when the audience would like to switch a channel A to a channel B, the video playing system 40 will query a current status of the channel B and acquire a status information of the channel B. When the current status of the channel B is the “program playing” status, the video playing system 40 will directly switch to the channel B. When the current status of the channel B is the “commercial playing” status, the video playing system 40 will notify the audience with a message showing the channel B is playing commercials. The video playing system 40 will also ask the audience whether to continue switching channel, for example, asking the audience to press a key to confirm the switching operation. Otherwise, the video playing system 40 will wait for the response from the audience for a predetermined time period, then close the notifying message and stay on the channel A. The operation flow of the method is described in detail as follows.

In step 501, the playing unit 402 of the video playing system 40 is playing the video contents of channel A. In step 502, the input unit 401 receives an input command from the audience to select another channel B. In step 503, the query unit 403 queries a current status (or playing status) of the channel B. In step 504, the receiving unit 406 receives the current status (or playing status) of the channel B. In step 505, the control unit 405 determines the current status (or playing status) of the channel B. In the step 505, when the control unit 405 determines that the current status of the channel B is the “commercial playing” status, the step 506 is executed after the step 505; when the control unit 405 determines that the current status of the channel B is the “program playing” status, the step 507 is executed after the step 505.

In the step 506, the playing unit 402 notifies the audience with a message that the channel B is playing commercial(s) (for example, displaying a message of “commercial playing”), and asks the audience whether to continue switching to channel B. In the step 507, the playing unit 402 is switched to the channel B directly. In step 508, the control unit 405 determines whether the audience wants to switch to channel B within a predetermined time period. The predetermined time period is, for example, 5 seconds. In the step 508, when the control unit 405 determines that the audience wants to switch to channel B (for example, the audience presses a key of the input device to confirm the channel switching), the step 507 is executed after the step 508. When the control unit 405 determines that the audience does not want to switch to channel B (for example, a confirmation command is not received from the audience or the audience cancels the channel switching), a step 509 is executed after the step 508. In the step 509, the playing unit 402 stays on the channel A. After the step 507 or 509, the switching channel method ends.

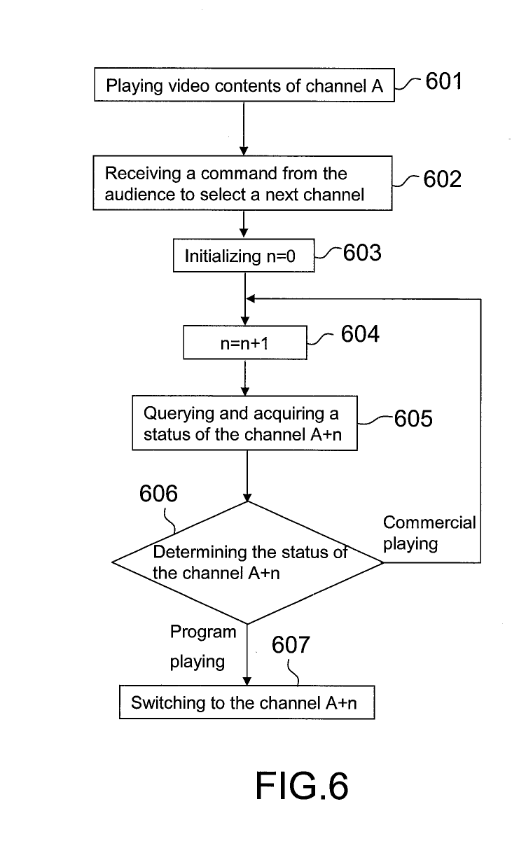

FIG. 6 is a flowchart illustrating a switching channel method according to another embodiment of the present invention. Referring to FIG. 4 and FIG. 6, in the embodiments, when the audience presses a CH down key or a CH up key on a remote controller to switch the channel sequentially, the video playing system 40 determines whether to skip a subsequent channel based on the status of the subsequent channel. If the status of the subsequent channel is “commercial playing”, the video playing system 40 will determine to skip the subsequent channel and query the status of the channel next to the subsequent channel. The video playing system 40 will keep querying and skipping channels until it determines the status of a channel is “program playing”. The operation flow of the method is described in detail as follows.

In step 601, the playing unit 402 of the video playing system 40 is playing the video contents of channel A. In step 602, the input unit 401 receives a command that the audience presses a “CH down” key on the remote controller to switch to a next channel. In step 603, the counter 404 initializes a value n as an integer and sets the value n equal to 0. In step 604, the counter 404 adds 1 to the value n, i.e., n=n+1. In step 605, the query unit 403 queries the status information (or playing status) of a channel A+n, and the receiving unit 406 acquires the status information (or playing status) of the channel A+n. In step 606, the control unit 405 determines the status information (or playing status) of the channel A+n. In the step 606, when the control unit 405 determines that the current status of the channel A+n is in the “commercial playing” status, the flow will return to the step 604 after the step 606. When the control unit 405 determines that the current status of the channel A+n is in the “program playing” status, the step 607 is executed after the step 606. In the step 607, the playing unit 402 switches to the channel A+n. After the step 607, the switching channel method ends.

The aforementioned method for switching channel of FIG. 6 can include following steps from another point of view. When the video contents of the first channel are played, a command inputted by the audience to switch to a next channel is received. The status information of the second channel following the first channel in sequence will then be queried and acquired. Moreover, when the status information of the second channel is the “commercial playing” status, a status information of a third channel following the second channel in sequence will then be queried. Such steps will be repeated until a channel in the “program playing” status is found. The video playing device will then switch to channel directly when the “program playing” status of the channel is acquired.

The present invention is not limited thereto, and in other embodiments of the present invention, when an input command inputted by the audience to switch to the previous channel (CH up) is received during playing a first channel (channel A), the counter 404 will initialize a value n and adds 1 to the value n. Then, the query unit 403 will query a status information (or playing status) of the channel A-n, and the receiving unit 406 will acquire the status information (or playing status) of the channel A-n. The control unit 405 will then determine the playing status of the n^{th} preceding channel of the first channel. When the n^{th} preceding channel of the first channel is in the “commercial playing” status, the counter 404 continually adds 1 to the value n. When the n^{th} preceding channel of the first channel is in the “program playing” status, the playing unit 402 is directly switched to the n^{th} preceding channel of the first channel.

The method for switching channel may include following steps from another point of view. When the video contents of the first channel are played, a command inputted by the audience to switch to a previous channel is received. Then, the status information of the preceding channel of the first channel, the second channel, will be queried and acquired. Moreover, when the second channel is in a “commercial playing” status, the playing status of the preceding channel of the second channel, the third channel, will then be queried. Such steps are repeated until a channel in a “program playing” status is found. The video playing device will then switch to the channel directly when the “program playing” status of the channel is acquired.

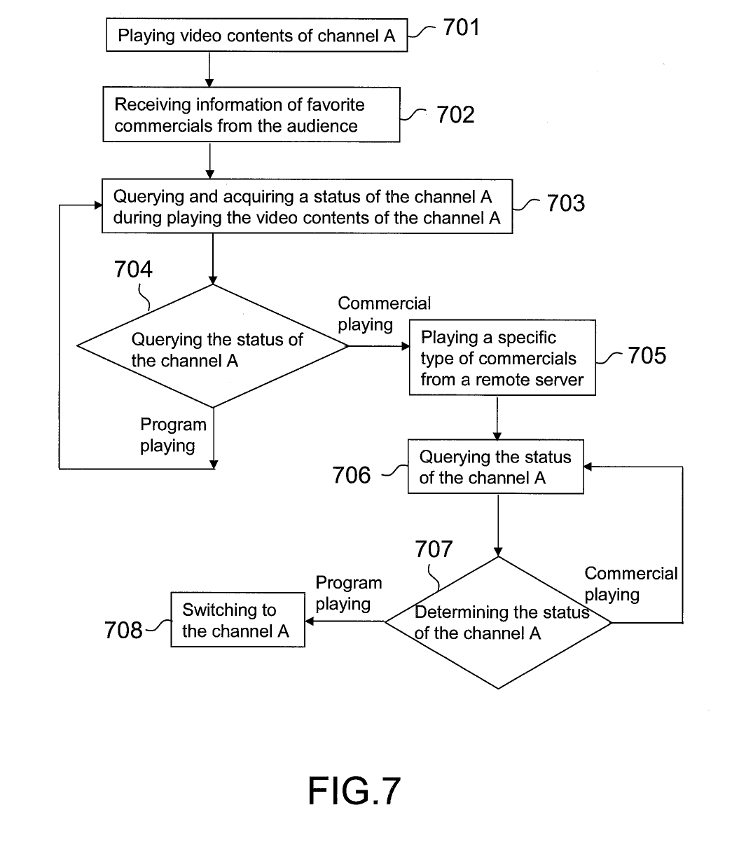

FIG. 7 is a flowchart illustrating a switching channel method according to another embodiment of the present invention. Referring to FIG. 4 and FIG. 7, in the embodiment, the audience can input information of the favourite commercials, such as categories, and transmit it to a remote server. When a currently played program or channel of the video playing system 40 is in commercial time or enters the “commercial playing” status, the video playing system 40 executes a specific application to receive and play a specific type of commercials provided by the remote server. When the originally played program or channel is resumed to the “program playing” status, the video playing system 40 switches to the originally watched channel or program. The operation flow of the method is described in detail as follows.

In step 701, the playing unit 402 of the video playing system 40 is playing video contents of the channel A. In step 702, the input unit 401 receives the information of favourite commercials from the audience, for example, the audience can input the favourite categories of the commercials. In step 703, during playing the video contents of channel A, the query unit 403 queries the current status information (or playing status) of the channel A, and the receiving unit 406 receives the current status information of the channel A. In step 704, the control unit 405 determines the current status (or playing status) of the channel A. In the step 704, when the control unit 405 determines that the channel A is the “commercial playing” status, a step 705 is executed after the step 704. When the control unit 405 determines that the channel A is still in the “program playing” status, the flow returns to the step 703 after the step 704.

In the step 705, the playing unit 402 plays the specific type of commercials received from the remote server, where the commercials are selected according to the information of the favourite commercials inputted by the audience. In step 706, the query unit 403 queries the current status (or playing status) of the channel A, and the receiving unit 406 receives the current status of the channel A. In step 707, the control unit 405 determines the current status (or playing status) of the channel A. In the step 707, when the control unit 405 determines that the channel A is in the “commercial playing” status, the flow returns to the step 706 after the step 707. When the control unit 405 determines that the channel A is in the “program playing” status, the flow goes to the step 708 after the step 707. In the step 708, the playing unit 402 switches to the channel A. After the step 708, the switching channel method ends.

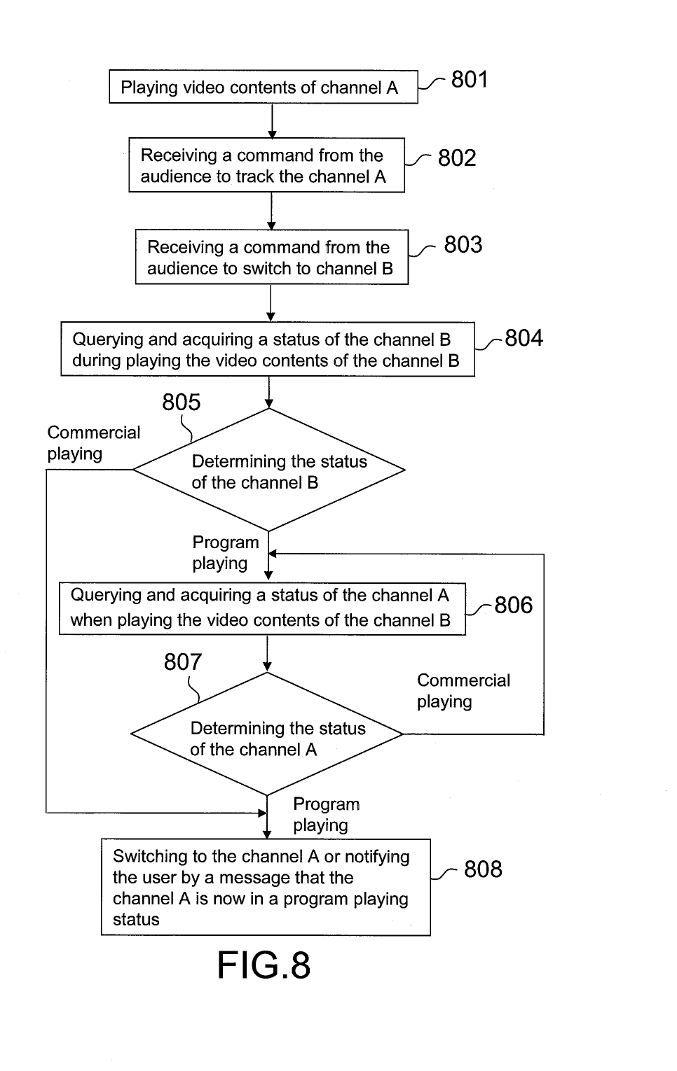

FIG. 8 is a flowchart illustrating a switching channel method according to another embodiment of the present invention. Referring to FIG. 4 and FIG. 8, in the embodiments, the audience sets a function to track a specific channel in the video playing system 40. When the channel currently watched by the audience is in the “commercial playing” status, to the video playing device 40 will switch to another channel. The video playing system 40 may constantly query the status of the specific channel or channels. Once commercials end in the originally watched channel, the video playing system 40 can automatically switch back to the originally watched channel or notify the audience with a message. The operation flow of the method is described in detail as follows.

In step 801, the playing unit 402 of the video playing system 40 is currently playing video contents of the channel A. In step 802, the input unit 401 receives a command inputted by the audience to track the channel A. In step 803, the input unit 401 receives a command inputted by the audience to switch to the channel B, and the playing unit 402 switches to the channel B. In step 804, the query unit 403 queries the status information (or playing status) of the channel B when the playing unit 402 is playing the video contents of channel B, and the receiving unit 406 acquires the current status of the channel B. In step 805, the control unit 405 determines the current status (or playing status) of the channel B. In the step 805, when the control unit 405 determines that the channel B is in the “commercial playing” status, a step 808 is executed after the step 805. When the control unit 405 determines that the channel B is in the “program playing” status, a step 806 is executed after the step 805.

In the step 806, when the playing unit 402 plays the video contents of channel B, the query unit 403 also queries the current status information (or playing status) of the channel A, and the receiving unit 406 acquires the current status information (or playing status) of the channel A. In step 807, the control unit 405 determines the current status (or playing status) of the channel A. In the step 808, the playing unit 402 switches to channel A, or the audience is notified with a message that the channel A is now in the “program playing” status. After the step 808, the switching channel method ends.

In summary, the embodiments of the present invention provide the methods for switching channels and the video playing systems thereof. According to the systems and the methods of the present invention, behaviours of efficiently switching the channels can be provided to reduce an unpleasant experience, which is resulted from the disturbance of commercials, of the audience, so the experience of the audience in channel switching can be improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A channel switching method, adapted to a video playing system, comprising the steps of:
receiving and playing video of a first channel;
receiving a command to select a second channel;
querying information indicating a status of the second channel;
acquiring information indicating the status of the second channel and determining the status of the second channel; and
switching to the second channel and playing video of the second channel if the second channel is not in a commercial playing status.

2. The channel switching method according to claim 1, further comprising:
notifying the audience with a message if the second channel is in a commercial playing status.

3. The channel switching method according to claim 2, further comprising:
determining whether a command to confirm the switching to the second channel is received within a predetermined time period.

4. The channel switching method according to claim 3, further comprising:
switching to the second channel and playing video of the second channel if the command to confirm the switching is received with in the predetermined period of time.

5. The channel switching method according to claim 1, wherein the step of querying information indicating the status of the second channel comprises querying an external device for the information indicating the status of the second channel.

6. The channel switching method according to claim 5, wherein the external device is a server or another video playing system.

7. The channel switching method according to claim 5, further comprising:
receiving information indicating the external device; and
connecting to the external device for querying information indicating the status of the second channel.

8. A channel switching method, adapted to a video playing system, comprising steps of:
receiving and playing video of a first channel;
receiving a command to switch to a previous or next channel of the first channel;
querying and acquiring information indicating a status of a second channel which is arranged previous or next to the first channel;
determining the status of the second channel;
if the second channel is not in a commercial playing status, switching to the second channel and playing video of the second channel; and
if the second channel is in a commercial playing status, querying information indicating a status of a third channel which is arranged previous or next to the second channel.

9. The channel switching method according to claim 8, the step of querying information indicating the status of the second channel comprises querying an external device for the information indicating the status of the second channel.

10. The channel switching method according to claim 9, wherein the external device is a server or another video playing system.

11. The channel switching method according to claim 9, further comprising:
receiving information indicating the external device; and
connecting to the external device for querying information indicating the status of the second channel.

12. A channel switching method, adapted to a video playing system, comprising steps of:
receiving a command to track a first channel;
receiving and playing video of a second channel;
querying and acquiring information indicating a status of the first channel;
determining the status of the first channel; and
if the first channel is in a program playing status, switching to the first channel and playing the video of the first channel.

13. The channel switching method according to claim 12, further comprising:
returning to the step of determining the status of the first channel if the first channel is not in a program playing status.

14. The channel switching method according to claim 12, further comprising:
notifying the audience with a message if the first channel is in a program playing status.

15. The channel switching method according to claim 12, further comprising:
acquiring the information indicating a status of the second channel when playing the video contents of the second channel.

16. The channel switching method according to claim 15, further comprising:
if the second channel is not in a program playing status, switching to the first channel and playing the video of the first channel.

17. The channel switching method according to claim 12, wherein the step of querying and acquiring information indicating the status of the first channel comprises querying an external device for the information indicating the status of the first channel.

18. The channel switching method according to claim 17, wherein the external device is a server or another video playing system.

19. The channel switching method according to claim 17, further comprising:
receiving information indicating the external device; and
connecting to the external device for querying information indicating the status of the first channel.

20. The channel switching method according to claim 19, wherein a server is connected to the video playing system to provide information indicating the external device.
